(19) United States
(12) Patent Application Publication
(10) Pub. No.: US 2009/0109107 A1
(43) Pub. Date: Apr. 30, 2009

(54) Apparatus and Method for Providing Single Plane Beam Shaping

(75) Inventors: Daniel G. Gonzalez, Topanga, CA (US); Leslie E. Oliver, Thousand Oaks, CA (US)

Correspondence Address: CROWELL & MORING LLP;INTELLECTUAL PROPERTY GROUP, P.O. BOX 14300, WASHINGTON, DC, 20044-4300, US

(73) Assignee: Malibu Research Associates, Inc., Camarillo, CA (US)

(21) Appl. No.: 11/933,079

(22) Filed: Oct. 31, 2007

(51) Int. Cl. H01Q 3/00; H01Q 19/00

(52) U.S. Cl. 343/756; 343/762

(57) ABSTRACT

An antenna assembly is provided having a primary feedhorn arranged in a first plane and configured to provide a first scan pattern having a first gain and first beamwidth. In another embodiment, a plurality of feedhorns are configured to provide a second scan pattern, wherein each of the plurality of feedhorns may be oriented substantially parallel to the first plane. A support structure may be provided to arrange the primary feedhorn in the first plane and the plurality of feedhorns substantially in parallel to the first plane. According to another embodiment, the first and second scan patterns produce a resulting scan pattern having a resultant beamwidth greater than the first beamwidth and a resultant gain that is greater than a minimum gain requirement.

### FIELD OF THE INVENTION

The present invention relates in general to antennas for scanning and radar applications, and more particularly to an antenna assembly configured to provide increased beamwidth of the antenna assembly beam pattern while maintaining gain.

### BACKGROUND

Conventional directional antennas have been utilized for a plurality of applications including transmitting and receiving electromagnetic energy, communications applications, radar and scanning applications, etc. However, current requirements demand directional antennas to provide increased beamwidth while maintaining an acceptable level of gain. Increasing beamwidth while maintaining an acceptable level of gain is not achievable by conventional directional antenna devices or systems. Conventional directional antennas are limited by an inherent operating characteristic of the directional antenna. It is generally accepted that directional antennas produce a radiation pattern having a gain parameter inversely proportional to beamwidth of the antennas radiation pattern. Accordingly, the gain of a particular antenna may be related to the antennas beamwidth as indicated in formula 1.

$$Gain ∝ \frac{1}{bandwidth} \qquad Formula 1$$

A directional antenna having a high level of gain generally provides increased range and signal quality. However, increasing the gain of directional antenna generally decreases beamwidth of the antennas scan pattern. As may be appreciated, conventional directional antennas may be designed for a particular gain. However, designing a conventional directional antenna for a particular gain imposes substantial limitations on the antennas beamwidth as shown in FIG. 4.

Referring to FIG. 4, a graphical representation 400 is provided for illustrating the relationship between antenna gain and beamwidth for a conventional directional antenna 405. As shown, conventional directional antenna 405 can provide a first radiation scan pattern 410a, wherein the first radiation scan pattern 410a is associated with a first configuration of the conventional directional antenna 405. The first configuration of the conventional directional antenna 405 corresponds to a particular design of the conventional directional antenna 405. Further, the first radiation scan pattern 410a may be characterized by a first gain 415a and a first beamwidth 420a. Similarly, FIG. 4 illustrates the effect of increasing beamwidth for conventional directional antenna 405 as shown in a second radiation scan pattern 410b. Similar to the first radiation scan pattern 410a, second radiation scan pattern 410b may be characterized by a second beamwidth 420b and a second gain parameter 415b. Thus, attempting to increase beamwidth of a conventional directional antenna results in a second radiation scan pattern 410b having a substantially decrease in gain, as indicated by second gain parameter 415b.

Conventional directional antenna systems and methods have not provided a solution to satisfy current requirements for a high gain directional antenna with increased beamwidth.

### BRIEF SUMMARY OF THE INVENTION

Disclosed and claimed herein is an antenna assembly. In one embodiment, the antenna assembly includes a primary feedhorn arranged in a first plane and configured to provide a first scan pattern having a first gain and first beamwidth. The antenna assembly may further include a plurality of feedhorns configured to provide a second scan pattern, wherein each of the plurality of feedhorns are oriented substantially in parallel to the first plane. According to another embodiment of the invention, the antenna assembly includes a support structure configured to arrange the primary feedhorn in the first plane and the plurality of feedhorns substantially in parallel to the first plane. The antenna assembly may further be configured to provide a resulting scan pattern having a resultant beamwidth greater than said first beamwidth and a resultant gain that is greater than a minimum gain requirement.

Other aspects, features, and techniques of the invention will be apparent to one skilled in the relevant art in view of the following detailed description of the invention.

### BRIEF DESCRIPTION OF THE DRAWINGS

FIG. 1 depicts a perspective view if a directional antenna according to one or more embodiments of the invention;

FIG. 2 depicts a directional antenna according to one or more embodiments of the invention;

FIGS. 3A-B depict operating characteristics of antenna arrangement according to one embodiment of the directional antenna of FIG. 1;

FIG. 4 depicts operating characteristics of a conventional directional antenna;

FIG. 5 depicts a graphical representation of a gain requirement according to one embodiment of the directional antenna of FIG. 1; and

FIG. 6 depicts a graphical representation of resultant antenna energy according to one embodiment of the directional antenna of FIG. 1.

### DETAILED DESCRIPTION OF EXEMPLARY EMBODIMENTS

One aspect of the invention is to provide an antenna assembly configured to increase beamwidth of a beam pattern while maintaining gain of the beam pattern in one embodiment, the directional antenna assembly may comprise a primary feedhorn, a plurality of feedhorns and a support structure arranging the primary feedhorn and the plurality of feedhorns. According to another embodiment, the antenna assembly may be provided having a compact structure.

According to another embodiment of the invention, a directional antenna may be configured to provide single plane beam shaping configured to increase beamwidth of a beam pattern while maintaining gain. In certain embodiments, the directional antenna may be employed for scanning and tracking applications, as well as telemetry applications such as transmitting data relative to at least one of an Unmanned Aerial Vehicle (UAV) and/or a ground station

Another aspect of the invention is to provide a mounting structure for a planar scanning antenna of the invention. The mounting structure may be configured to provide rotation of a directional antenna arranged by the mounting structure. The mounting structure may include a rotating base. In certain embodiments, the mounting structure may further be provided for housing electrical connections to a plurality of feed assemblies.

As used herein, the terms “a” or “an” mean one or more than one. The term “plurality” mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

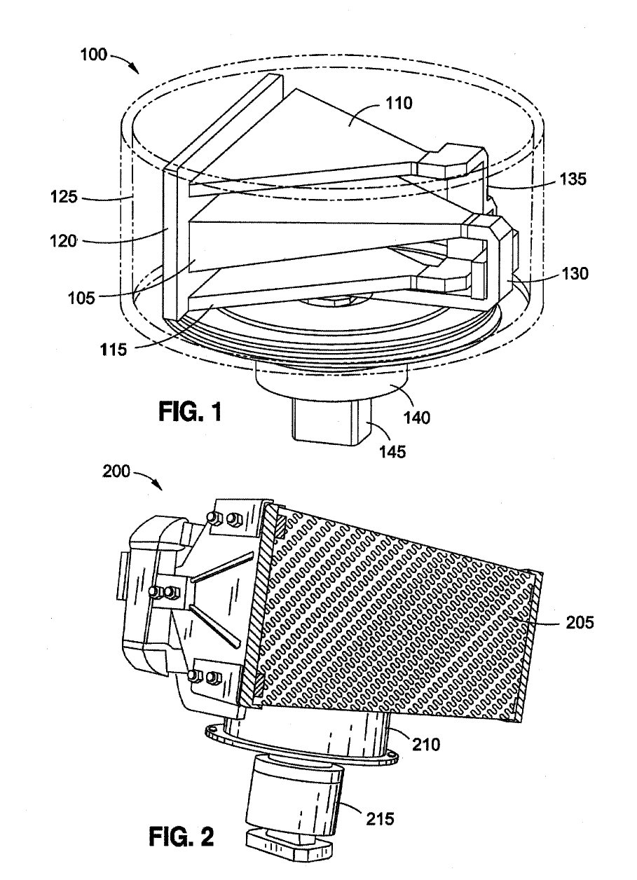

Referring now to FIG. 1, antenna assembly 100 is shown according to one or more embodiments of the invention. As shown, antenna assembly 100 includes a primary feedhorn 105 and a plurality of feedhorns comprised of feedhorn 110 and feedhorn 115. In one embodiment, primary feedhorn 105 may be one of a pyramidal, conical or corrugated configuration.—Similarly, the plurality of feedhorns 110 and 115 may be provided by a plurality of pyramidal, conical or corrugated feedhorns. As such, the primary feedhorn 105 the plurality of feedhorns 110 and 115 may provide electromagnetic energy that may be characterized by a scan pattern.

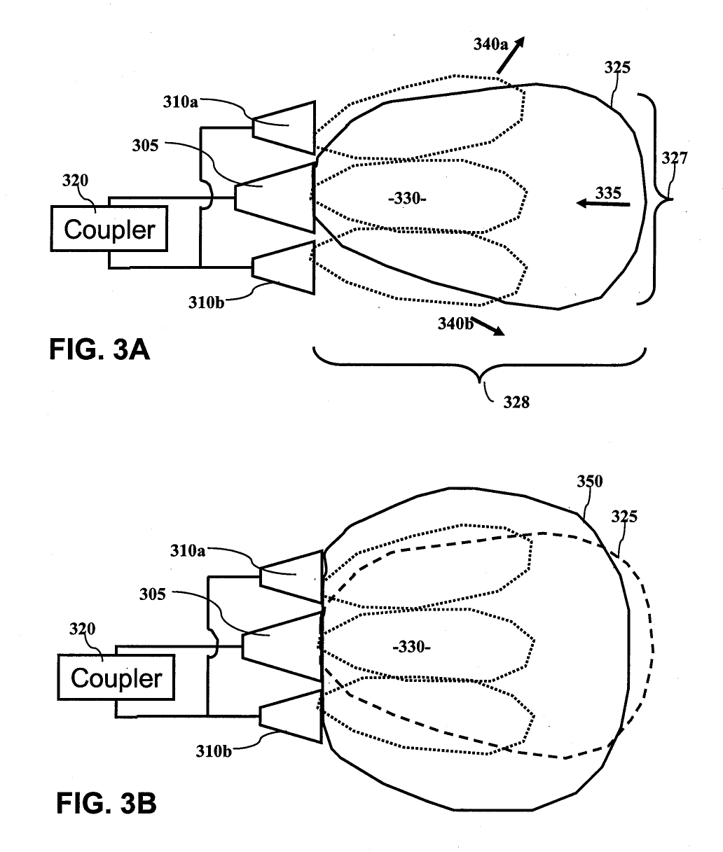

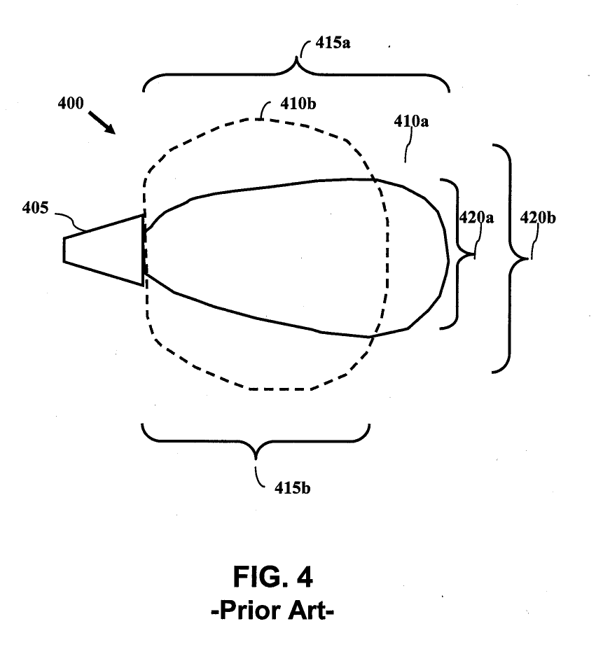

According to one embodiment of the invention, primary feedhorn 105 and the plurality of feedhorns 110 and 115 may be employed to provide increased beamwidth of a beam pattern while maintaining gain of the beam pattern as will be described in more detail below with reference to FIG. 3. In that fashion, antenna assembly 100 may provide beam shaping for increase beamwidth. In another embodiment, antenna assembly 100 may be configured to provide a directional beam. In one embodiment, the directional beam may be a single plane beam in the elevation plane. Although the plurality of feedhorns 110 and 115 is shown including two feedhorns, it may be appreciated that the plurality of feedhorns may employ additional feedhorns. Additionally, antenna assembly 100 may be configured to provide an unsymmetrical pattern by providing a single feedhorn in addition to the primary feedhorn.

According to another embodiment of the invention, antenna assembly 100 may include polarization plate 120. Polarization plate 120 may be employed by antenna assembly 100 to provide and/or to accept, either left or right hand circularly polarized electromagnetic energy to maximize reception by antenna assembly 100. For example, polarization plate 120 may be employed to impart one of horizontal, linear and circular polarization to incident electromagnetic energy applied to the plate. Polarization plate 120 may convert linearly polarized electromagnetic energy from antenna assembly 100 to either right hand or left hand circular polarization on transmit. Conversely, the polarization plate 120 can convert received right or left hand circularly polarized electromagnetic energy to linear polarization. According to another embodiment, antenna assembly 100 may include radome 125 to provide an enclosure for primary feedhorn 105 and the plurality of feedhorns 110 and 115. Radome 125 is shown transparently reveal inner components of antenna assembly 100. It may be appreciated that, radome 125 may be embodied as a solid enclosure. For example, radome 125 may be embodied as a sealed enclosure which may be used to protect antenna assembly 100. Additionally, radome 125 may be weatherproof. According to another embodiment, radome 125 may be configured to exhibit a relatively low attenuation on incident electromagnetic energy. Radome 125 may be constructed of at least one of plastic, rexolite, fiberglass or any electromagnetically transparent and structurally stable material.

According to another embodiment, antenna assembly 100 may include support assembly 130 configured to arrange primary feedhorn 105 and the plurality of feedhorns 110 and 115 in a fixed position. Support structure 130 may be configured to arrange primary feedhorn 110 in a first plane and the plurality of feedhorns 110 and 115 in a second plane that is substantially in parallel to the first plane. In that fashion, antenna assembly 100 may be configured to provide a scan pattern having increased beamwidth while maintaining gain. According to another embodiment, support structure 130 may be configured to house electrical connections to primary feedhorn 105 and the plurality of feedhorns 110 and 115. Further, support structure 130 may include secondary support structure 135 configured to arrange the plurality of feedhorns 110 and 115. In yet another embodiment, support structure 130 may be mechanically coupled to a base member 140. Base member 140 may be employed to couple antenna assembly 100 to mounting structure 145.

Referring now to FIG. 2, antenna assembly 200 is shown according to another embodiment of antenna assembly 100 of FIG. 1 with radome 125 removed. As shown, antenna assembly 200 includes base member 210 (e.g., corresponding to base member 140 of FIG. 1) configured to couple antenna assembly 200 to a rotatable base 215. As such, antenna assembly 200 may be employed to provide a 360° scan radius. According to another embodiment, antenna assembly 200 includes polarization plate 205 (e.g., polarization plate 120) configured to provide, and/or to accept, polarized electromagnetic energy. Accordingly, antenna assembly 200 may be configured to have an operational frequency range within 1 to 100 GHz.

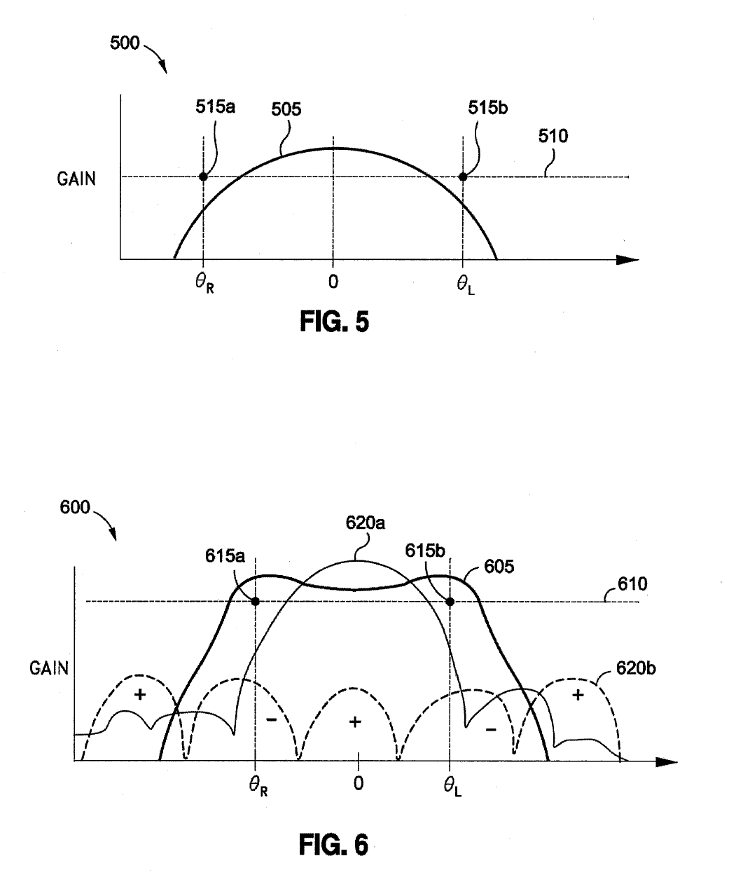

Referring now to FIGS. 3A-3B, a simplified block diagram of a feedhorn arrangement is shown as may be employed by antenna assembly 100 of FIG. 1. Referring to FIG. 3A, a primary feedhorn 305 (e.g., corresponding to primary feedhorn 105) is shown arranged between a plurality of feedhorns 310a-b (e.g., corresponding to plurality of feedhorns 110). Primary feedhorn 305 and the plurality of feedhorns 310a-b may be coupled to a coupler/processing circuitry 320. According to one embodiment, primary feedhorn 305 may be configured to generate electromagnetic energy such as a single plane beam having a scan pattern 325. In addition, scan pattern 325 as generated by primary feedhorn 305 may be characterized by a corresponding beamwidth 327 and a corresponding gain value 328 that exceeds a required minimum gain by a predefined signal margin, which is described below in more detail with respect to FIG. 5. Further, scan pattern 325 may be characterized as having a gain value that exceeds a required minimum gain by a predefined signal margin. In one embodiment, scan pattern 325 may be one of a relatively wide beam and a flat beam. Similarly, the plurality of feedhorns 310a-b may be configured to generate electromagnetic energy in the form of a single plane beam which may be characterized by a tri-lobe scan pattern 330. Scan pattern 330 may correspond to any variations of a cosecant-squared beam shape.

According to one aspect of the invention, primary feedhorn 305 and the plurality of feedhorns 310a-b may be employed to provide a resulting scan pattern having increased beamwidth while producing gain above a minimum requirement. In that fashion, beam shaping may be provided. In one embodiment of the invention, single plane beams 325 and 330, as shown in FIG. 3A, may be employed as components of the resulting scan pattern,. Accordingly, the single plane beams 325 and 330 may be integrated such that scan pattern 325 is shaped as indicated by direction 335. Similarly, scan pattern 330 may be shaped as indicated by directions 340a-b. To that end, a scan pattern may be provided having increased beamwidth while maintaining gain as shown in FIG. 3B.

In one embodiment, beam shaping may be provided by integration of component beams 325 and 330. For example, coupler 320 may be configured to integrate beams 325 and 330 using waveguide coupling slots. In one embodiment, coupler 320 may be a Moreno coupler.

Referring now to FIG. 3B, a feedhorn arrangement is shown including a primary feedhorn 305, a plurality of feedhorns 310a-b and a resulting scan pattern 350 exhibiting increased beamwidth while maintaining gain. As such, resulting scan pattern 350 may correspond to integration of single plane beams 325 and 330 as indicated by directions 335 and 340a-b. According to one embodiment, resulting scan pattern 350 may be generated by primary feedhorn 305 and the plurality of feedhorns 310a-b. Resulting scan pattern 350 may be a single plane beam having a widened beamwidth with a flat gain response. According to another embodiment of the invention, scan pattern 350 may have a beamwidth in the range of ±21°. Similarly, beamwidth of resulting scan pattern 350 may meet requirements as described below in more detail with respect to FIG. 6. Further, resulting scan pattern 350 may have a gain on the order of 15 to 16 dB at 15 GHz.

Additionally shown in FIG. 3B, an exemplary scan pattern 355 is shown as may be provided by the plurality of feedhorns 310a-b according to one embodiment of the invention. Scan pattern 355 may correspond to electromagnetic energy provided the plurality of feedhorns 310a-b contributing to resulting scan pattern 350. As shown, the plurality of feedhorns 310a-b is characterized as a pair of feedhorns. However, it may be appreciated that additional feedhorns may be employed.

Referring now to FIG. 5, a graphical representation 500 is shown of feedhorn gain 328 of FIG. 3A in relation to elevation angle according to one or more embodiments of the invention. Feedhorn gain 505 is shown in relation to a minimum gain requirement 510 and minimum beamwidth requirement as indicated by 515a-b. In one embodiment, feedhorn gain 505 may be characterized as having a gain value that exceeds a minimum gain requirement 510 by a predefined signal margin. In one embodiment, feedhorn gain 505 may exceed a minimum gain requirement by a signal margin within the range of 2-3 dB at the center of the beam. As shown in FIG. 5, feedhorn gain 328 is a representative pattern from a single horn, which only meets the gain requirement in the central portion of the beam, and falls below the required gain nearer to Ø(L) and Ø(R). Feedhorn gain 505 does not meet beamwidth requirement as indicated by 515a-b. In one embodiment feedhorn gain 505 may be incorporated to provide a scan pattern to meet a minimum gain requirement 510 and a beamwidth requirement as indicated by 515a-b as further described below with reference to FIG. 6.

Referring now to FIG. 6, a graphical representation 600 is shown of antenna assembly gain 605 in relation to elevation angle in the elevation plane for one embodiment of the invention. Graphical representation 600 additionally provides feedhorn gain 620a for a primary feedhorn (e.g., primary feedhorn gain 505) and feedhorn gain 620b for a plurality of feedhorns (e.g., plurality of feedhorns 310a-b). According to one embodiment of the invention, resulting gain 605 for an antenna assembly may be achieved by providing feedhorn gain 620a for a primary feedhorn in combination with providing feedhorn gain 620b for the plurality of feedhorns. Antenna assembly gain 605 is shown in relation to a minimum gain requirement 610 and minimum beamwidth requirement as indicated by 615a-b. As shown, resulting gain 605 exceeds the minimum gain requirement 610, as well as the beamwidth requirement as indicated by 615a-b according to one or more embodiments of the invention. According to another embodiment, resulting gain 605 may exceed a minimum gain requirement 510 by a signal margin of up to 1 dB at the extreme limits of the scan region.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. An antenna assembly, which comprises:
a primary feedhorn arranged in a first plane configured to provide a first scan pattern having a first gain and first beamwidth;
a plurality of feedhorns configured to provide a second scan pattern, each of the plurality of feedhorns oriented substantially in parallel to the first plane; and
a support structure configured to arrange said primary feedhorn in said first plane and said plurality of feedhorns substantially in parallel to said first plane such that the first and second scan patterns produce a resulting scan pattern having a resultant beamwidth greater than said first beamwidth and a resultant gain that is greater than a minimum gain requirement.

2. The antenna assembly of claim 1, wherein the support structure is configured to arrange one of said plurality of feedhorns above said primary feedhorn and one of said plurality of feedhorns below said primary feedhorn.

3. The antenna assembly of claim 1, wherein the first gain exceeds the minimum gain by a predefined signal margin.

4. The antenna assembly of claim 1, further comprising a coupler electrically coupled to said primary feedhorn and said plurality of feedhorns.

5. The antenna assembly of claim 4, wherein said coupler is configured to control beam shape of said resulting scan pattern.

6. The antenna assembly of claim 4, wherein said beam shape is a single plane beam shape.

7. The antenna assembly of claim 1, further comprising a rotatable base coupled to the support structure.

8. The antenna assembly of claim 1, further comprising a polarizing plate configured to polarize scan patterns.

9. The antenna assembly of claim 8, wherein the polarizing plate comprises one of a vertical, horizontal, circular and any polarization plate in general.

10. An antenna assembly, which comprises:
a first horn antenna arranged in a first plane configured to provide a first scan pattern having a first gain and first beamwidth;
a second horn antenna arranged in a second plane that is substantially parallel to the first plane configured to provide a second scan pattern;
a third horn antenna arranged in a third plane that is substantially parallel to the first plane configured to provide a third scan pattern; and
a support structure configured to arrange said first horn antenna in said first plane such that the first, second and third scan patterns produce a resulting scan pattern having a resultant beamwidth greater than said first beamwidth and a resultant gain that is greater than a minimum gain requirement.

11. The antenna assembly of claim 10, wherein the support structure is configured to arrange said second horn antenna above said first horn antenna and said third horn antenna below said first horn antenna.

12. The antenna assembly of claim 10, wherein the first gain exceeds the minimum gain by a predefined signal margin.

13. The antenna assembly of claim 9, further comprising a coupler electrically coupled to said first, second and third horn antennas.

14. The antenna assembly of claim 13, wherein said coupler is configured to control a beam shape of said resulting scan pattern.

15. The antenna assembly of claim 14, wherein said beam shape is a single plane beam shape.

16. The antenna assembly of claim 10, further comprising a rotatable base coupled to the support structure.

17. The antenna assembly of claim 10, further comprising a polarizing plate configured to polarize scan patterns.

18. The antenna assembly of claim 17, wherein the polarizing plate comprises one of a vertical, horizontal, circular and any polarization plate in general.
